(19) United States
(12) Patent Application Publication
(10) Pub. No.: US 2024/0412070 A1
(43) Pub. Date: Dec. 12, 2024

(54) Systems and Methods for Latent Variable Modeling of Multiscale Neural Signals for Brain-Computer Interfaces

(71) Applicants: Emory University, Atlanta, GA (US); Northwestern University, Evanston, IL (US)

(72) Inventors: Brianna Karpowicz, Brookhaven, GA (US); Chethan Pandarinath, Decatur, GA (US); Marc Slutzky, Northbrook, IL (US); Robert Flint, Chicago, IL (US); Yahia Ali, Peachtree Corners, GA (US); Bareesh Bhaduri, Atlanta, GA (US)

(21) Appl. No.: 18/737,515

(22) Filed: Jun. 7, 2024

Related U.S. Application Data
(60) Provisional application No. 63/471,574, filed on Jun. 7, 2023.

(51) Int. Cl. G06N 3/088

(52) U.S. Cl. CPC G06N 3/088

(57) ABSTRACT

Systems and methods for reconstructing spiking data from local field potential data are provided. In one implementation, the computer-implemented method may include receiving a training dataset of neural data for at least one subject. The training dataset may include measured field potential data and measured spiking data. In some examples, the method may further include training a neural network architecture to estimate spiking data from the field potential data. The neural network architecture may include a dynamics model.

### CROSS-REFERENCE TO RELATED APPLICATIONS

This application claims the benefit of U.S. Provisional Application No. 63/471,574 filed Jun. 7, 2023. The entirety of this application is hereby incorporated by reference for all purposes.

### STATEMENT REGARDING FEDERALLY SPONSORED RESEARCH OR DEVELOPMENT

This invention was made with government support under NS127291 awarded by the National Institutes of Health. The government has certain rights in the invention.

### BACKGROUND

Brain-computer interfaces (BCI) translate neural signals to commands capable of controlling devices, such as robotic hardware, neural prostheses, prosthetics, input devices (e.g., for typing and/or speech), etc. With recent advances in neural recording technologies, neural data is being collected in unprecedented volumes with hundreds to thousands of neurons per recording session. Alongside these advances, it has become more difficult to analyze the activity of such large populations of individual neurons. As such, latent variable models (LVMs) have become an important tool in understanding the patterns contained in neural activity. To date, LVMs have relied solely on the ability to extract spiking data from recorded neural activity, as it tends to yield subsequent analyses with the highest accuracy and precision. However, this process can be unreliable as implanted neural recording hardware may experience signal degradation due to immune responses of surrounding tissue or unstable placement with respect to nearby neurons.

### SUMMARY

Thus, there is a need for a more reliable techniques that use spiking data to control brain-computer interfaces.

Techniques disclosed herein relate generally to training and using a neural network architecture that includes a dynamics model to reconstruct spiking data from local field potential data. The disclosed techniques can improve decoding performance of using collected spiking data because field potential data has demonstrated to be more robust over long timescales than spiking data.

According to some embodiments, the computer-implemented method may include receiving a training dataset of neural data for at least one subject. The training dataset may include measured field potential data and measured spiking data. In some examples, the method may further include training a neural network architecture to estimate spiking data from the field potential data. The neural network architecture may include a dynamics model.

According to some embodiments, a system may include one or more processors; and one or more hardware storage devices having stored thereon computer-executable instructions which are executable by the one or more processors to cause the computing system to perform operations. The operations may include receiving a training dataset of neural data for at least one subject. The training dataset may include measured field potential data and measured spiking data. In some examples, the operations may further include training a neural network architecture to estimate spiking data from the field potential data. The neural network architecture may include a dynamics model.

According to some embodiments, a computer-program product tangibly embodied in a non-transitory machine-readable storage medium may include instructions configured to cause one or more data processors to perform operations. The operations may include receiving a training dataset of neural data for at least one subject. The training dataset may include measured field potential data and measured spiking data. In some examples, the operations may further include training a neural network architecture to estimate spiking data from the field potential data. The neural network architecture may include a dynamics model.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The disclosure can be better understood with the reference to the following drawings and description. The components in the figures are not necessarily to scale, the emphasis being placed upon illustrating the principles of the disclosure.

FIG. 1 illustrates an example of a system environment for determining a brain state using a trained neural network architecture according to some embodiments.

FIG. 2 is a flow chart illustrating an example of a process for training the neural network architecture using training data for a subject according to some embodiments.

FIG. 3 is a flow chart illustrating an example of a process for the training step shown in FIG. 2 according to some embodiments.

FIG. 4 is a flow chart illustrating an example of a process for estimating spiking data from local field potential data using a trained neural network architecture according to some embodiments.

FIG. 5 illustrates an example of a neural network architecture according to some embodiments

FIG. 6A illustrates a comparison of three different model types, including the neural network architecture described in this disclosure, trained on 5 separate datasets collected on different days. FIG. 6B show an illustrative summary of performance of the four tested methods shown in FIG. 6A.

FIG. 7 illustrates another example of neural network architecture according to some embodiments.

FIG. 8 shows a table of LFADS model architecture parameters used in a study using the neural network architecture shown in FIG. 7.

FIG. 9 shows a table of LFADS model hyperparameters used in the study using the neural network architecture shown in FIG. 7.

FIG. 10 shows a table of LFADS model hyperparameters for each frequency band used in the study using the neural network architecture shown in FIG. 7.

FIG. 11 shows a schematic of a wireless intracortical brain-computer interface (iBCI) circuit and power advantages conferred by LFP using the neural network architecture shown in FIG. 7.

FIGS. 12A-C show a visualization of LFP power at different quantization levels. FIG. 12A shows LFP power in the 150-450 Hz band before quantization at its original float 64 bit depth and after quantization at various lower bit depths of 4 bits; FIG. 12B shows LFP power in the 150-450 Hz band before quantization at its original float 64 bit depth and after quantization at various lower bit depths of 8 bits, and FIG. 12C shows LFP power in the 150-450 Hz band before quantization at its original float 64 bit depth and after quantization at various lower bit depths of 16 bits.

FIGS. 13A-F show illustrative examples of the LFP-based dynamics models reconstruct firing rates and enable high-accuracy behavioral decoding in a monkey center-out reaching task using the architecture shown in FIG. 7. FIG. 13A shows a schematic of center-out reaching task. FIG. 13B shows example PSTHs for three example channels from a single session for smoothed LFP power, smoothed spikes, Spikes LFADS rates, and LFP LFADS rates. Each shade is a different reach direction, with solid lines indicating the trial average of neural activity for a given condition 250 ms before to 500 ms after the computed movement alignment time and shaded regions representing the standard error of the mean. FIG. 13C shows velocity decoding performance (R²) for LFP LFADS compared to empirical LFP power (left) and Spikes LFADS (right). Each point represents the R² value for a model trained on one session of data; five sessions were evaluated in total. Dashed black line indicates unity. FIG. 13D shows measured single trial reach trajectories, shaded by target location for a single session (left): and reach position trajectories integrated from the decoded reach velocity when a decoder is trained on each of the four neural signal modalities (right). Data and R² shown for the same single session as in FIG. 13B. LFP power in the band 150-450 Hz, 64-bit resolution. FIG. 13E shows decoding performance of LFP-based dynamics models when using input features from different frequency bands of LFP to reconstruct spikes. FIG. 13F shows decoding performance of LFP-based dynamics models when using LFP power features (150-450 Hz) computed at different resolutions.

FIGS. 14A-C show illustrative examples of LFP-based dynamics models uncover neural dynamics and accurately decode reach velocity in a monkey random target reaching task. FIG. 14A shows a schematic of random target reaching task. FIG. 14B shows projections of neural activity onto the top condition-independent dPC and top 2 condition-dependent dPCs. The dPC parameters were determined using the LFP LFADS denoised firing rates and applied to all four representations of neural activity: LFP LFADS rates, Spikes LFADS rates, Empirical Spikes, and Empirical LFP. All neural signals were smoothed with a 30 ms Gaussian kernel prior to PCA for visualization. Each reach is considered the submovement from one target to the next and is aligned in the window 200 ms before and 500 ms after the alignment point. Trajectories are shaded by relative angle between the targets. FIG. 14C shows two-dimensional true cursor position trajectories for three example trials, with targets indicated as blue squares; earlier targets are shaded lighter and later targets are shaded darker (top). Example decoded cursor velocities for three trials of 6 submovements each (bottom). Decoded velocity components are shown for decoders trained to predict from LFP LFADS rates, Spikes LFADS rates, Empirical Spikes smoothed with a 30 ms Gaussian, and Empirical LFP power in the 150-450 Hz frequency band smoothed with a 30 ms Gaussian. The start of each reach is indicated with the round marker, and target acquisition time is shown with a shaded square. True cursor velocity is shown by the black trace, and predicted cursor velocity from each neural signal modality is shown by a different shaded trace.

FIGS. 15A-D show illustrative examples of LFP-based dynamics models reconstruct firing rates and enable phoneme decoding in an attempted speech task using the architecture shown in FIG. 7. FIG. 15A shows a schematic of a trial in the attempted speech task, in which participant T16 was asked to attempt to say one of fifty words. FIG. 15B shows an example PSTHs for three example channels from a single session for smoothed LFP power, smoothed spikes, Spikes LFADS rates, and LFP LFADS. Each shade is a different word (see legend at bottom), with solid lines indicating the trial average of neural activity for a given word 1000 ms before to 1000 ms after the computed speech onset time and shaded regions representing the standard error of the mean. FIG. 15C shows validation phoneme error rate (PER) for models trained with each of the four input features: Smoothed LFP power, Smoothed Spikes, Spikes LFADS rates, or LFP LFADS rates. Five decoders were trained with different random seeds. The height of each bar indicates the mean PER across the five decoders and the black error bar indicates one standard deviation. FIG. 15D show an example decoded outputs for each of the four input signal types in ARPAbet notation.

FIG. 16 is a simplified block diagram of an example of a computing system for implementing certain embodiments disclosed herein.

### DESCRIPTION OF THE EMBODIMENTS

In the following description and Appendix, numerous specific details are set forth such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

While examples of the disclosure may be specific to controlling a device, such as a prosthetic device, using a brain-computer interface, it will be understood that these examples are nonlimiting and that the methods and systems may be used to control stimulation delivered by other devices such as a therapeutic neurostimulation device. In some examples, the brain-computer interface may be a wired or wireless device.

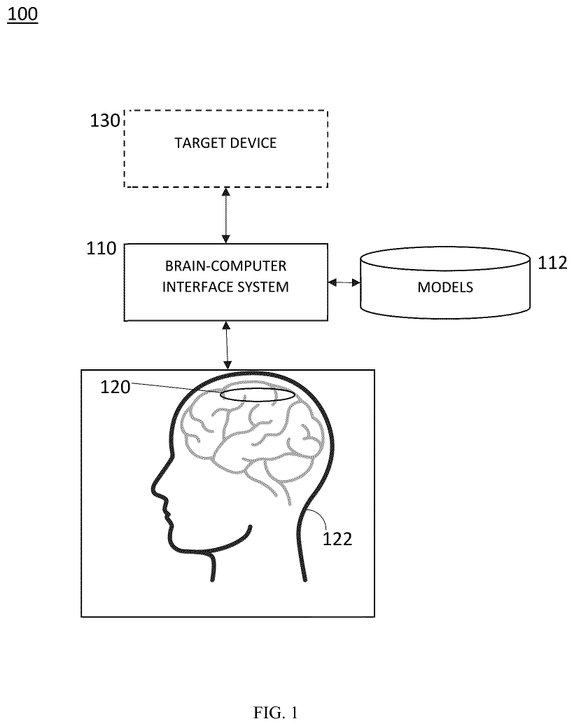

FIG. 1 depicts an example system environment 100 that can include a brain-computer interface system 110 configured to decode neural data of a user 122 recorded using one or more sensors (e.g., microelectrode array) 120 that has been processed using a trained neural network architecture stored in a database 112 to a command, corresponding to a brain state, for controlling a target device 130 according to some embodiments. In some embodiments, the neural data may be recorded as at least one raw neural signal indicative of brain activity received from at least one sensor (e.g., electrode) for a period of time, for example, from a continuous feed. This raw neural signal can be processed to determine (measured) local field potential data and/or spiking data.

In some examples, the trained neural architecture may be configured to determine an estimate of spiking data from the (measured) local field potential data to determine denoised firing rates. By extracting only the more reliable local field potential data from the implanted neural recording hardware to determine an estimate of spiking data using the trained neural architecture, the decoding performance using the spiking data/denoised firing rates can be maintained even when the implanted neural recording hardware experiences signal degradation.

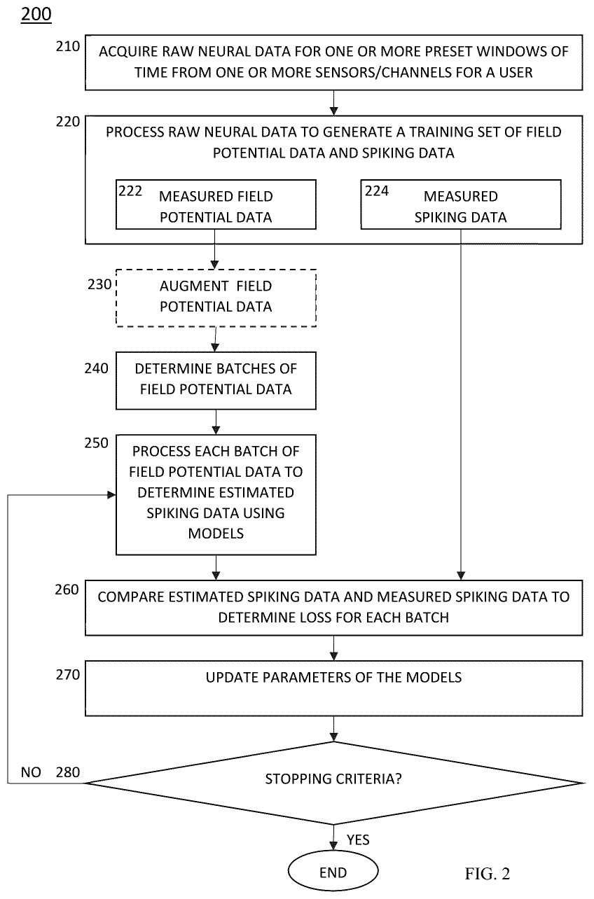

In some examples, the trained neural architecture may be trained using the (measured) spiking data and field potential training data. FIGS. 2, 3, 5, and 7 show examples of training the trained neural architecture according to some embodiments

In some examples, the trained neural architecture may include a latent dynamics model trained to process the measured field potential data to obtain latent dynamics trajectories. In some examples, the latent dynamics model may include but is not limited to latent factor analysis via dynamical systems (LFADS) models, iterative linear quadratic regulator variational autoencoder (iLQR-VAE) models, other recurrent neural network (RNN)-based models; Poisson Latent Neural Differential Equations (PLNDE) models, other neural ordinary differential equations (NODE)-based models; Neural Data Transformer (NDT) models, other transformer-based models; among others, or any combination thereof.

In some examples, the trained neural architecture may further include a read-out model trained to process the estimated latent dynamic trajectories to determine an estimate of the spiking data. In some examples, the estimates of the spiking data may be estimates of the firing rates underlying the spiking data, for example, a denoised version of the spiking data. The read-out model may include but is not limited to a linear transformation/matrix, a feedforward network, among others, or any combination thereof.

In some examples, the trained neural architecture may also optionally include a read-in model trained to process the measured field potential data to a standardized dimension. By way of example, the dimension may include but is not limited to channel dimension and/or time dimension. In some examples, the measured field potential data may be augmented (e.g., drop channels, time shift, change mean value, etc.) before processing through the read-in layer. In some examples, the read-in model may include but is not limited to a linear transformation/matrix, a feedforward network, a convolutional network, among others, or any combination thereof.

In some embodiments, the brain-computer interface system 110 may be any brain-computer interface system including but not limited to a wired intracortical brain-computer interface system, a wireless intracortical brain-computer interface system, other brain-computer interface systems, among others, or a combination thereof. In some embodiments, the system 110 may include any computing or data processing device consistent with the disclosed embodiments. In some embodiments, the system 110 may incorporate the functionalities associated with a personal computer, a laptop computer, a tablet computer, a notebook computer, a hand-held computer, a personal digital assistant, a portable navigation device, a mobile phone, an embedded device, a smartphone, and/or any additional or alternate computing device/system. The system 110 may transmit and receive data across a communication network. In some embodiments, the system 110 may be envisioned as a brain-computer interface controlling the target device 130 according to the decoded neural data.

In some embodiments, the one or more sensors 120 may be operatively connected (invasively and/or non-invasively) to the user 122 and configured to generate one or more signals (“neural signals”) responsive to the user's brain activity. In some embodiments, the one or more sensors 120 may be any currently available or later developed invasive sensor(s), non-invasive(s) sensors, or any combination thereof. In some examples, the one or more sensors 120 may be operatively connected with a motor cortex of the user. For example, the sensor(s) may include a microelectrode array disposed in the brain (e.g., primary motor cortex, premotor cortex, parietal cortex, cingulate cortex, etc.) of the user configured to obtain neural data; a wearable neural recording device (e.g., integrated into a headband, hat, eyeglasses, other head-worn article, among other, or any combination thereof) that can be disposed outside of the skull and configured to obtain neural data (e.g., from the primary motor cortex) noninvasively, such as a human machine/computer interface; among others; or any combination thereof. For example, the one or more sensors 120 can include a plurality of EEG electrodes (either “wet” or “dry” electrodes) configured to generate multi-channel EEG data responsive to the user's brain activity.

In some embodiments, the target device 130 may include but is not limited to a communication device (e.g., typed, displayed, audible, etc.), robotic arm or device, full limb prosthesis, partial limb prosthesis, neuroprosthesis or functional electrical stimulation (FES) device that actuates a paralyzed limb, an orthotic device, a deep brain stimulation device, a remote hands free device (e.g., a robot or an unmanned aerial vehicle), a motor vehicle, a cursor on a computer screen, among others, or a combination thereof. In some examples, such as a deep brain stimulation device, the sensor(s) 120 and the target device 130 (e.g., stimulating electrodes) may be provided in a single device.

In some embodiments, the system 110 may be configured to communicate with the one or more sensors 120, the target device 130, another programming or computing device via a wired or wireless connection using any of a variety of local wireless communication techniques, such as RF communication according to the 802.11 or Bluetooth specification sets, infrared (IR) communication according to the IRDA specification set, or other standard or proprietary telemetry protocols. The system 110 may also communicate with other programming or computing devices, such as the target device 130, or one or more sensors 120, via exchange of removable media, such as memory cards. In other embodiments, the one or more sensors 120 and/or the target device 130 may incorporate the functionalities discussed and associated with the system 110.

Although the systems/devices of the environment 100 are shown as being directly connected, the system 110 may be indirectly connected to one or more of the other systems/devices of the environment 100. In some embodiments, the system 110 may be only directly connected to one or more of the other systems/devices of the environment 100.

It is also to be understood that the environment 100 may omit any of the devices illustrated and/or may include additional systems and/or devices not shown. It is also to be understood that more than one device and/or system may be part of the environment 100 although one of each device and/or system is illustrated in the environment 100. It is further to be understood that each of the plurality of devices and/or systems may be different or may be the same. For example, one or more of the devices may be hosted at any of the other devices.

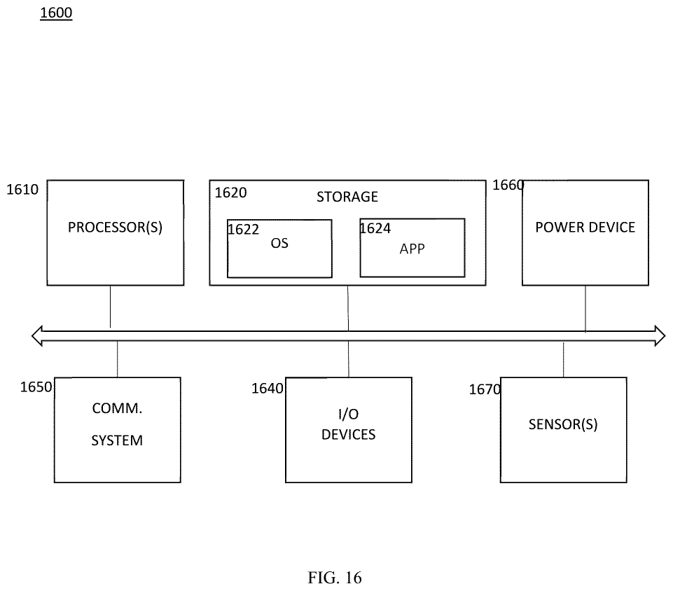

FIGS. 2-5 and 7 show flow charts according to some embodiments. Operations described in flow charts 200-400 and architectures 500 and 700 may be performed by a computing system, such as the system 110 described above with respect to FIG. 1 or a computing system described below with respect to FIG. 16. Although the flow charts 200-400 and architectures 500 and 700 may describe the operations as a sequential process, in various embodiments, some of the operations may be performed in parallel or concurrently. In addition, the order of the operations may be rearranged. An operation may have additional steps not shown in the figure. In some embodiments, some operations may be optional. Embodiments of the method/architecture may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium.

FIG. 2 shows flow chart 200 illustrating an example of a process for training a neural network architecture to estimate spiking data from the field potential data according to some embodiments. Operations in flow chart 200 may begin at block 210, the system 110 may receive raw neural data associated with one or more users for a period of time recorded from the one or more sensors 120. For example, the raw neural data may be received from a microelectrode array disposed in the motor cortex of a user. In some examples, the raw neural data may correspond to voltage signals recorded for one or more preset windows of time from one or more sensors/channels of a sensor for a user.

In some embodiments, the system 110, at block 220, may process the raw neural data to determine measured field potential data 222 and measured spiking data 224. The measured filed potential data 222 and measured spiking data 224 may correspond to a training set of neural data used to train the neural network architecture.

In some embodiments, the system 110, at block 230, may optionally augment the field potential data 222. In some examples, one or more augmentations may be applied to the field potential data 222. The one or more augmentations may include but is not limited to drop channels, shift data in time, change mean value of data, other augmentations that mimic changes that occur in empirical data over time, among others, or any combination thereof.

Next, at block 240, the system 110 may determine a plurality of batches of field potential data from the measured field potential data 222 from block 220 or the augmented field potential data from block 230.

In some examples, at block 240, the system 110 may first determine samples of field potential data from the measured field potential data 222 from block 220 or the augmented field potential data from block 230. The samples may correspond fixed-length overlapping and/or overlapping window of time. Next, the samples may be randomly assembled into one or more batches having a fixed number of samples. This way, each set of training data from block 220 may generate one or more batches to train the neural network architecture.

Next, at blocks 250-270, the system 110 may process each batch through the neural network architecture to train the architecture to estimate spiking data from the field potential data. In some examples, each batch may be processed at blocks 250-270 in parallel. At block 250, the system 110 may process each batch through the neural network architecture to estimate the spiking data.

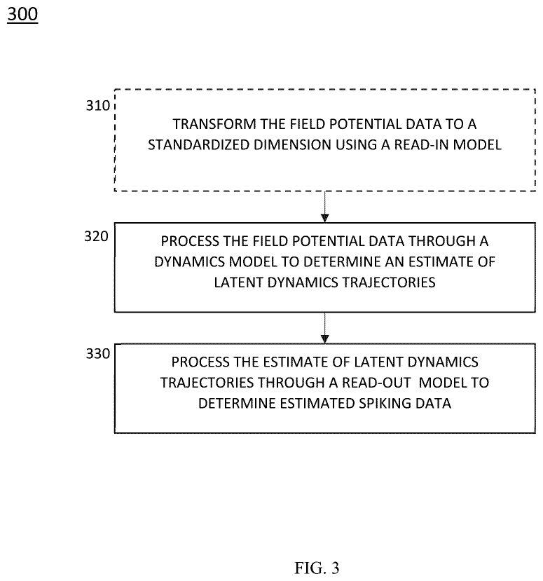

FIG. 3 shows a flow chart 300 illustrating an example of the process performed at block 250. For example, at block 310, the system 110 may optionally transform the field potential data of each batch to standardized dimension(s) (referred to as “standardized field potential data”) using the read-in model. For example, the neural data may be transformed to a standardized channel dimension and/or time dimension. For example, this can address if one or more of the sensors and/or channels malfunction.

In some embodiments, the system 110, at block 320, may process the field potential data of each batch from block 240 and/or block 310, through the dynamics model to determine an estimate of latent dynamics trajectories. For example, the latent dynamic trajectories may be a vector of the values corresponding to one or more brain state variables in a latent data space for a series of time points.

In some embodiments, at block 330, the system 110 may process the estimated latent dynamics trajectories through the read-out model to determine estimated spiking data.

In some embodiments, at block 260, the system 110 may compare the estimated spiking data to the measured spiking data corresponding to the samples of the batch to determine loss. In some examples, the loss may be determined using Poisson negative log likelihood loss function, other log-likelihood cost function for a specific parameterized noise model (e.g., Poisson, Gaussian, Gamma, Binomial, etc.), mean-squared error (SE), among others, or any combination thereof.

In some embodiments, at block 270, based on the reconstruction cost, one or more parameters of the model(s) of the neural network architecture can be updated, for example via backpropagation of the loss. For example, for each model, the one or more parameters may include but is not limited to weights of the model parameters, biases of the model parameters, among others, or any combination thereof.

Next, the training of the neural network architecture, at blocks 250-270, using a batch may be repeated for that batch until the stopping criteria has been met at block 280. For example, the stopping criteria may include a maximum number of epochs (processing at blocks 250-270) has been reached, the loss has stopped changing after a set number of epochs, the learning rate has decreased according to some schedule beyond a minimum value, among others, or a combination thereof.

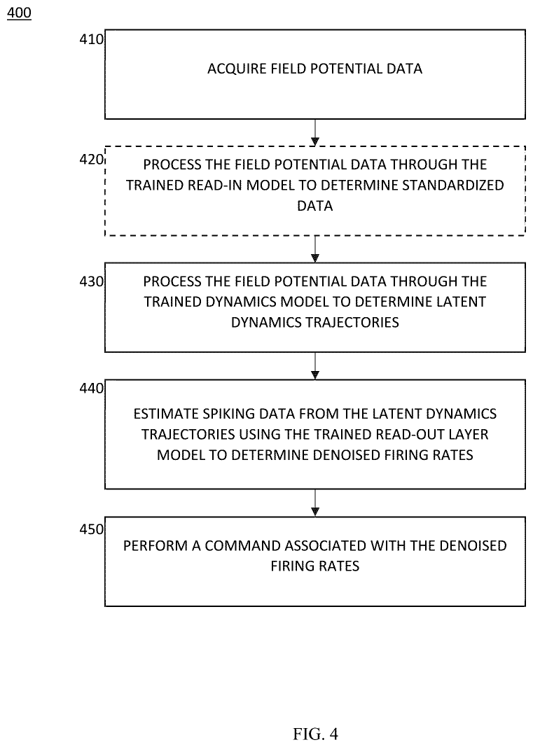

FIG. 4 shows a flowchart illustrating an example of a process for estimating spiking data from measured field potential data using the trained neural network architecture, for example, trained according to processes of FIGS. 2 and 3, for controlling the target device 130 according to some embodiments. For example, the system 110 may cause movement of a robotic or prosthetic limb, a peripheral device (e.g., a computer mouse, vehicle, etc.), stimulation of the brain of the user, action by a communication device, among others, or any combination thereof.

In some embodiments, at block 410, the system 110 may receive raw neural data associated with a user for a period of time recorded from the one or more sensors 120. For example, the raw neural data may be received from a microelectrode array disposed in the motor cortex of a user. In some examples, the raw neural data may correspond to voltage signals recorded for one or more preset windows of time from one or more sensors/channels of a sensor for a user. In some embodiments, the system 110 may process the raw neural data to determine measured field potential data.

For example, at block 420, the system 110 may process the field potential data through the trained read-in model to transform the field potential data to standardized dimension(s) (referred to as “standardized field potential data”) using the trained read-in model. For example, the neural data may be transformed to a standardized channel dimension and/or time dimension. For example, this can address if one or more of the sensors and/or channels malfunction.

In some embodiments, the system 110, at block 430, may process the field potential data from block 410 or block 420, through the trained dynamics model to determine an estimate of latent dynamics trajectories.

In some embodiments, at block 440, the system 110 may process the estimated latent dynamics trajectories through the train read-out model to determine estimated spiking data.

In some embodiments, at block 450, the system 110 may cause initiation of a command by the target device 130 corresponding to a state corresponding to the estimated spiking data and/or a state corresponding to the estimated spiking data and measured field potential data. For example, using the estimated spiking data, the system 110 may cause movement of a robotic or prosthetic limb, a peripheral device (e.g., a computer mouse, vehicle, etc.), stimulation of the brain of the user, action by a communication device, among others, or any combination thereof.

### EXAMPLES

Now, having described the embodiments of the disclosure, in general, the examples describe some additional embodiments. While embodiments of the present disclosure are described in connection with the examples and the corresponding text and figures, there is no intent to limit embodiments of the disclosure to these descriptions. On the contrary, the intent is to cover all alternatives, modifications, and equivalents included within the spirit and scope of embodiments of the present disclosure. As described above, the methods and systems disclosed herein can be used to reconstruct spiking data from local field potential data.

### Example 1

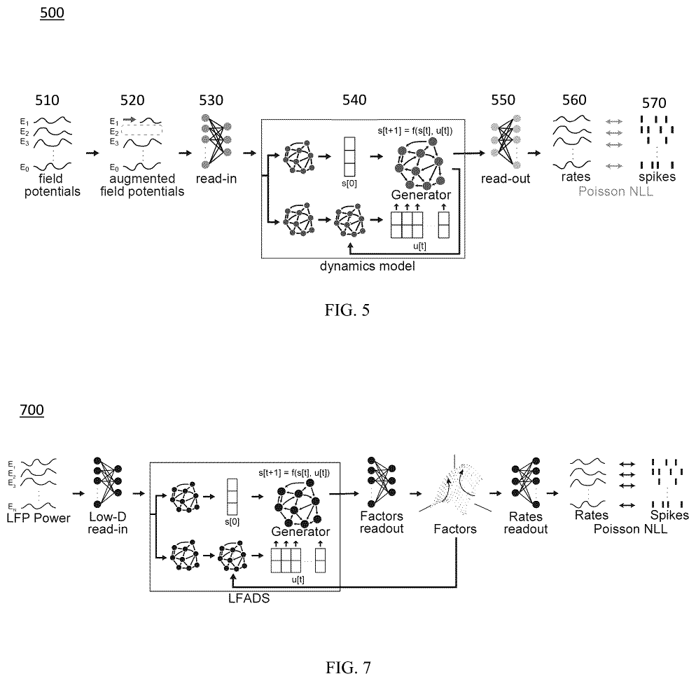

FIG. 5 illustrates an example 500 of a neural network architecture according to some embodiments. Field potential data 510 can optionally be augmented 520 before being fed into the first model of the neural network architecture, the read-in model 530. The read-in model 530 can standardize the dimensionality of the input data before passing it into the second model of the neural network architecture, the dynamics model 540. The dynamics model 540 can output estimated latent dynamics trajectories, which are then given to the third model of the neural network architecture, the read-out model 550 to construct estimated firing rates. The firing rates 560 may then be compared to the true spiking data 570 via a loss such as Poisson negative log likelihood (NLL) for training.

### Example 2

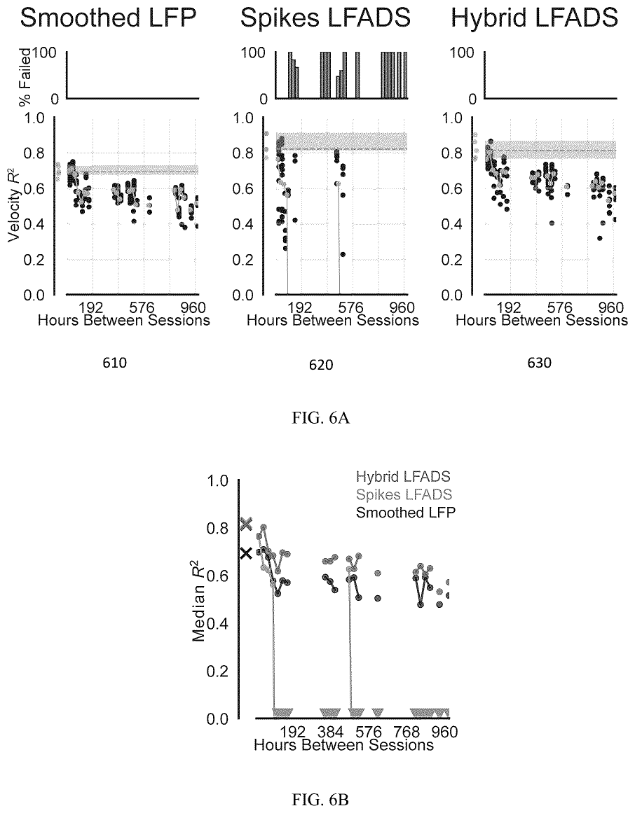

FIG. 6A illustrates a comparison of three different model types, including the neural network architecture described in this disclosure, trained on 5 separate datasets collected on different days. The model types include smoothed local field potential (LFP) (left), spikes to spikes dynamics model (center) and field potential to spikes dynamics model (right). Each model was trained on 5 separate datasets collected on different days (one model per dataset per model type). The data collected from the same subject but different time windows (“test sessions”) was passed through each trained model and velocity decoding performance was evaluated on the output rates. In particular, the decoding stability of the field potentials to spikes dynamics models were evaluated. The field potential to spikes models were compared to the output of the spikes to spikes dynamics models and to the smoothed field potential signal without a dynamics model applied. Within each plot, top: Percentage of decoding failures on test datasets (R2<0) in 24-hour bins. Bottom: Decoding performance as a function of hours between sessions. Black points indicate test session decoding performance for single pairs of days. Dark gray points/line show the median test performance within each bin of width 5 days. Light gray points denote initial performance for decoders (i.e., evaluated on held-out within-session data) for each of the 5 original datasets. Gray dashed lines indicate median decoding performance of original decoders, and shaded regions around them represent the first and third quartiles.

FIG. 6B shows an illustrative summary of performance of the four tested methods shown in FIG. 6A. In this plot diagram, the gray median lines from each of the left plots overlaid for ease of comparison. As shown, it can be concluded that the field potential to spikes models maintain the initial decoding performance more stably than alternatives.

### Example 3

Current intracortical brain-computer interfaces (iBCIs) rely predominantly on threshold crossings (“spikes”) as the neural activity that is decoded into a control signal for an external device. Spiking data can lead to high accuracy online control during complex behaviors; however, it can pose challenges for many applications due to its dependence on high-sampling-rate data collection. An alternative signal for iBCI decoding is the local field potential (LFP), which contains lower frequency components of neural activity that can be collected simultaneously with spiking activity. However, low-bandwidth LFP is not often used alone for online iBCI control as it may lead to slower and lower accuracy behavioral predictions. In these examples, to improve the performance of LFP-based decoders, a neural dynamics model was first trained to use LFP to reconstruct spikes, and then decoding from the reconstructed spikes. In these examples, these models were tested on previously-collected macaque data during center-out and random-target reaching tasks as well as data collected from a human iBCI participant during attempted speech. In all cases, training models from LFP can enable firing rate reconstruction with accuracy comparable to spiking-based dynamics models. In addition, LFP-based dynamics models can enable decoding performance exceeding that of LFP alone and approaching that of spiking-based models. In all applications except speech, LFP-based dynamics models also facilitate decoding accuracy exceeding that of empirical spikes. Finally, because LFP-based dynamics models operate on lower sampling rate input than spiking models, they may allow iBCI recording devices to operate with lower power requirements than devices that directly record spiking activity, without sacrificing high-accuracy decoding.

Intracortical brain-computer interfaces restore abilities to people with paralysis by monitoring their neural activity and mapping it to an external variable, such as intended cursor movements, actuations of a robotic effector, handwritten characters, spoken words, and even muscle activity. These devices often use implanted electrodes to measure millisecond-scale events known as threshold crossings or “spikes,” which are the predominant signal used to train decoding algorithms to translate neural activity into control signals for external effectors. Recent advances in recording interface technology have also brought to light the prospect of implantable wireless iBCI devices, which promise to offer further benefits to users by making devices safer and more portable.

A prominent consideration in designing wireless iBCIs is the power required for data collection and transmission, as high power requirements can necessitate large batteries to ensure sufficient battery life. While advantageous for decoding performance, spikes are at a disadvantage in terms of power consumption. To reliably identify spikes in the voltage signal recorded from an electrode array, neural data is usually collected at a high sampling rate of 30 kHz. While spikes can be binned and digitized to lower power requirements for wireless data transmission, the sampling rate and bandwidth demands result in costly high-power amplifiers and analog-to-digital converters. While recent studies have demonstrated that spikes can be extracted from lower bandwidth signals, the bandwidth must generally remain sufficiently high so as to not cause inaccurate firing rate estimates or degrade decoding performance.

These examples use a paradigm in which LFP power is used as input to LFP-based dynamics model, and the model's objective is to reconstruct the firing rates underlying spiking activity. In this paradigm, training the model requires LFP and spikes to be collected simultaneously. However, after training, only LFP is required to perform model inference and obtain firing rate estimations on new timepoints. Thus after an initial model training dataset is collected, further use of the model relies only on LFP, a low-power signal.

These examples demonstrate that LFP-based dynamics models can be a pre-decoding step for iBCIs that can allow low-power operation while maintaining the decoding performance of high-power, spikes-based counterparts. In these examples, by calculating the power requirements of various wireless iBCI circuit components for each signal modality, it has been found that recording LFP in place of spikes can reduce power consumption by an order of magnitude or more.

In these examples, model performance has been demonstrated on three datasets. For a variety of frequency bands and data resolutions, LFP-based dynamics models trained on a monkey center-out dataset yielded accurately-reconstructed firing rates and high-performance decoding comparable to that of spikes-based dynamics models. Also, on a less structured monkey random target reaching task, LFP-based dynamics models maintained their ability to accurately reconstruct firing rates and decode behavior. Finally, a human iBCI speech task was investigated and it was found that LFP-based dynamics models performed comparably to spikes-based dynamics models for phoneme decoding.

In all, these examples demonstrate that LFP-based dynamics models produce outputs that can be used to train decoders that perform better than LFP power alone and perform comparably to spikes-based dynamics models. This decoding advantage can be accompanied by a decrease in required power consumption to collect model input data post-training. Lower power consumption may overall benefit the development of wireless iBCIs by enabling longer battery life or the transmission of more channels. Overall, these results demonstrate that models of neural population dynamics can improve the potential of LFP to be used in real-world iBCIs.

### Methods and Materials

### Nonhuman Primate Data Collection

Previously-collected primate data were analyzed from two reaching tasks. See, e.g., Flint, R. D., Wright, Z. A., Scheid, M. R. & Slutzky, M. W. Long term, stable brain machine interface performance using local field potentials and multiunit spikes. J. Neural Eng. 10, 056005 (2013); and Flint, R. D., Ethier, C., Oby, E. R., Miller, L. E. & Slutzky, M. W. Local field potentials allow accurate decoding of muscle activity. J. Neurophysiol. 108, 18-24 (2012). A rhesus macaque was implanted with a 96-channel microelectrode array (Blackrock Neurotech, Inc.) in the arm area of primary motor cortex (M1). The monkey performed each reaching task with the arm contralateral to the array. Broadband data was collected from each electrode at 30 kHz using a 128-channel acquisition system (Cerebus, Blackrock Neurotech, Inc.). To extract spikes, the broadband data was high pass filtered (300 Hz cutoff) and thresholded using a threshold manually set for each channel (average threshold=5.2 standard deviations above mean potential). To extract LFP, the broadband data was first bandpass filtered from 0.5-500 Hz, then resampled the signal at 2 kHz, and finally notch filtered it at harmonics of 60 Hz for powerline noise removal.

The first task analyzed was an eight-target center-out reaching task. On each trial, the monkey began by holding at the center of a 10 cm-radius circle of targets for 0.5-0.6 s. Then, one of eight 2 cm square targets spaced at 45° intervals around the circle was illuminated. The monkey had to reach the outer target within 1.5 s and hold for a random time between 0.2-0.4 s to obtain a liquid reward. The second task was a random target reaching task. On each trial, the monkey had to acquire a series of 6 randomly positioned targets appearing one-at-a-time, holding each for 0.1 s, to obtain the reward. The targets spanned the majority of the 20-by-20 pixel workspace.

### Human Subject Data Collection

Participant T16 is a participant in the BrainGate2 clinical trial (ClinicalTrials.gov Identifier: NCT00912041). T16 is a right-handed woman, 52 years of age at the time of the study, with tetraplegia and dysarthria due to a pontine stroke that occurred approximately 19 years prior to study enrollment. Four 64-channel intracortical microelectrode arrays (Blackrock Microsystems, Salt Lake City, UT; 1.5 mm electrode length) were placed in her left precentral gyrus. In this study, data collected 69 days after implantation from only one of these arrays, which was located in the speech-related ventral precentral gyrus (6v), was analyzed. Broadband data u was recorded and processed using the Backend for Realtime Asynchronous Neural Decoding (BRAND) platform. See, e.g., Ali, Y. H. et al. BRAND: A platform for closed-loop experiments with deep network models. J. Neural Eng. (2024) doi: 10.1088/1741-2552/ad3b3a.

To extract the spiking data, the data using linear regression referencing (LRR) with respect to data collected immediately before the period of interest was first re-referenced. See, e.g., Young, D. et al. Signal processing methods for reducing artifacts in microelectrode brain recordings caused by functional electrical stimulation. J. Neural Eng. 15, 026014 (2018). Then, the data was bandpass filtered from 250-5000 Hz (4th order Butterworth filter) and finally identified threshold crossings with a threshold of −4.5 RMS. Then the LFP was extracted by processing the broadband data to be consistent with the nonhuman primate data as described above: we first low pass filtered the data with a 1000 Hz cutoff (5th order Butterworth filter), downsampled the signal to a 2 kHz sampling rate, and notch filtered at harmonics of 60 Hz to remove powerline noise.

Participant T16 performed a cued speech task in which she vocalized a word presented to her on a screen, similar to previous speech-related tasks. See, e.g., Card, N. S. et al. An accurate and rapidly calibrating speech neuroprosthesis. 2023.12.26.23300110 Preprint at https://doi.org/10.1101/2023.12.26.23300110 (2024); and Willett, F. R. et al. A high-performance speech neuroprosthesis. Nature 620, 1031-1036 (2023).The words were pooled from the 50 word vocabulary introduced by Moses et al. See, e.g., Moses David A. et al. Neuroprosthesis for Decoding Speech in a Paralyzed Person with Anarthria. N. Engl. J. Med. 385, 217-227 (2021). At the beginning of each trial, a red square appeared on the screen directly below a single word. After a delay period of 1500 ms, the square turned green, cueing the participant to vocalize the word to the best of her ability. After it was clear the participant was done speaking, an experimenter ended the trial. There was a 1000 ms interval before the next trial began.

### Data Preprocessing

### LFP

Before analysis, the raw LFP was further preprocessed by identifying and removing disconnected or overly active channels, computing LFP power, and causally normalizing the resulting signals. For some analyses, a Gaussian kernel was also applied to smooth the signal (standard deviation=30 ms for monkey data, 50 ms for T16 data).

To compute LFP power, using the raw 2 kHz LFP signal, a short-time Fourier transform (STFT) was computed using a frequency resolution of 5 Hz (except for the 0-8 Hz band, for which we used 2 Hz) and a hop size was computed by dividing the desired bin width (20 ms) by the current source bin width (0-1000 Hz, 0.5 ms; 150-450 Hz, 1.1 ms; 1006-200 Hz, 2.5 ms; 50-100 Hz, 5 ms; 25-50 Hz, 10 ms; 0-25 Hz, 20 ms). The magnitudes in the frequency bands of interest were identified and computed power by summing their values squared into 20 ms bins. For determining channels to remove, these power values were used to computed the mean within each channel. Channels that had mean power less than 50% of the median of the per-channel means (assumed disconnected) or greater than or equal to twice the 99th quantile of the per-channel means (overly active) were excluded. For modeling and other decoding-based analyses, the log of these power values were computed. The power was casually normalized by z-scoring it in each timestep using means and standard deviations computed from a 3-minute rolling window.

### Spikes

For the random target dataset, coincident spikes were first removed by zeroing the value at any time step at which a spike occurred on more than 30% of the channels. For all datasets, any channels involved in correlations higher than 0.2 when computed in 1 ms bins prior to modeling were first removed. Then, spikes into 20 ms bins by computing the cumulative sum of spike counts in each 20 ms time window were resampled. For some analyses, the spikes by convolving with a Gaussian kernel (standard deviation=30 ms for monkey data, 50 ms for T16 data) were also smoothed.

### Behavior

Behavior was analyzed by looking at windows around a movement alignment time. For both monkey reaching datasets, an alignment time was computed as the time at which the speed in the window starting 250 ms after trial start time crosses the threshold of 70% of the peak speed in each trial. The window of data 250 ms before to 500 ms was extracted after this alignment point. To avoid analyzing trials that may have had corrective movements or multiple speed peaks, any trial for which the first crossing computed from the start of the trial and the last crossing computed from the end of the trial did not match was rejected.

For the T16 data, the envelope of microphone data collected during the session by mean-centering the data, high-pass filtering with a cutoff of 65 Hz, rectifying the signal, low-pass filtering with a cutoff of 10 Hz were computed, and then the resulting envelope to 50 Hz to match the resolution of the neural data was downsampled. To determine speech onset points, a custom algorithm to be applied to this envelope was adapted. Looking at the region between the go cue and trial stop time, peaks in the differentiated envelope (positive peaks) and its inverse (negative peaks) were identified to identify increases and decreases in the signal. The first positive peak was selected as the speech onset and the last negative peak as the speech offset. In order to reduce sensitivity to outliers or noise, a minimum threshold for peak magnitude of 3.5 was set to ensure that peak detection only captured large-amplitude changes in the differentiated microphone envelope.

### Neural Dynamics Modeling

The neural dynamics model used in this example is latent factor analysis via dynamical systems (LFADS). See, e.g., Sussillo, D., Jozefowicz, R., Abbott, L. F. & Pandarinath, C. LFADS-Latent Factor Analysis via Dynamical Systems. ArXiv160806315 Cs Q-Bio Stat (2016); and Pandarinath, C. et al. Inferring single-trial neural population dynamics using sequential auto-encoders. Nat. Methods 15, 805-815 (2018). In short, LFADS models temporal patterns underlying neural activity using a series of recurrent neural networks. The input to the model is a neural signal s(t). The Generator RNN models the generic dynamical system as x{dot over (()}t)=f(x(t),u(t)). A Controller RNN models inputs to the dynamical system u(t). Encoder RNNs model the initial conditions x(0) and u(0). The objective of the model is to best reconstruct the rates [symbol] underlying the neural signal using a Poisson negative log likelihood (NLL) loss computed based on s(t).

In the original model (termed “Spikes LFADS” in this paper), s(t) is comprised of binned spiking data, and [symbol] is an estimate of the denoised firing rates learned by computing the Poisson NLL between [symbol] and s(t).

In this example, the input data s(t) with LFP power p(t) was replaced as shown in FIG. 7. The input to the model is now p(t), but the model's objective is still to estimate [symbol] by computing the Poisson NLL between [symbol] and s(t).

FIG. 7 shows an example of architecture of an adapted LFADS model used in this example. The input to the model is LFP Power in the desired frequency band. This signal is passed through a Low-D read-in matrix to standardize the dimensionality. These features are then passed into LFADS, which models them as a nonautonomous dynamical system. The output of LFADS is the Factors, which are a low-dimensional linear readout of the Generator RNN and represent the dynamics. The Factors can be linearly transformed through the Rates readout to estimate the firing rates underlying spiking data. The system is trained to uncover these firing rates using a Poisson NLL cost between the estimated firing rates and spikes used to train the model.

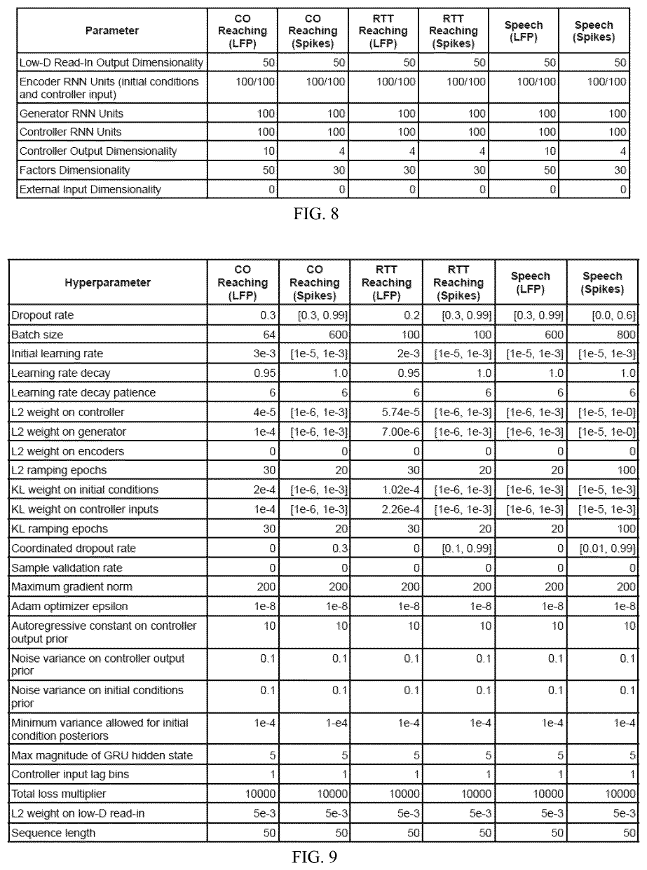

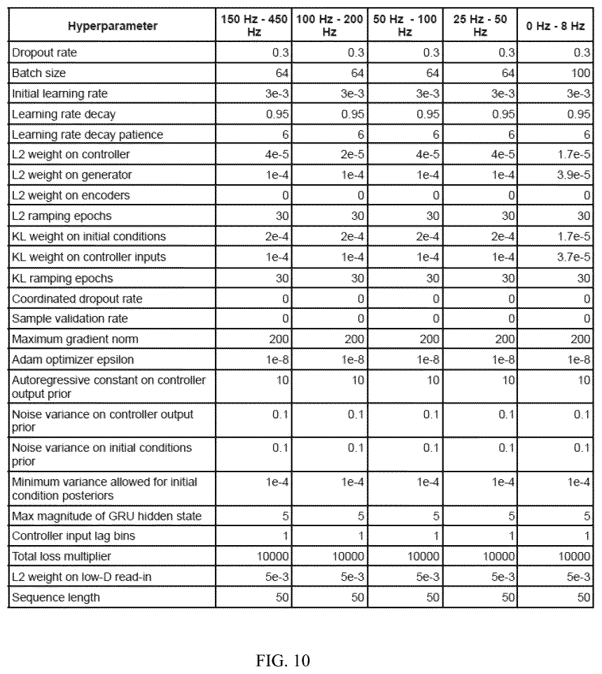

All data is modeled in an unsupervised manner with respect to trial structure. The continuous data is divided into segments as follows: 1000 ms windows with 200 ms overlap for center-out reaching datasets and 1000 ms windows with 350 ms overlap for random target reaching datasets and speech datasets. The LFADS models were trained with fixed architecture parameters provided in the table shown in FIG. 8. The hyperparameters of the LFP LFADS models were optimized using grid searches for both monkey datasets and using AutoLFADS for the speech dataset provided in the tables shown in FIGS. 9 and 10, and the hyperparameters of all Spikes LFADS models were optimized using AutoLFADS. See, e.g., Keshtkaran, M. R. et al. A large-scale neural network training framework for generalized estimation of single-trial population dynamics. Nat. Methods 19, 1572-1577 (2022). In addition, to aid in reducing overfitting to correlations between channels in the binned spiking data, Spikes LFADS models were trained with a data augmentation that randomly moved spikes up to 2 bins forward or backward in a different configuration on each training step. See, e.g., Karpowicz, B. M. et al. Stabilizing brain-computer interfaces through alignment of latent dynamics. 2022.04.06.487388 Preprint at https://doi.org/10.1101/2022.04.06.487388 (2022).

After training, models trained on monkey datasets used a causal inference procedure to obtain resulting LFADS factors and denoised firing rates. See, e.g., Ali, Y. H. et al. BRAND: A platform for closed-loop experiments with deep network models. J. Neural Eng. (2024) doi: 10.1088/1741-2552/ad3b3a; and Karpowicz, B. M. et al. Stabilizing brain-computer interfaces through alignment of latent dynamics. 2022.04.06.487388 Preprint at https://doi.org/10.1101/2022.04.06.487388 (2022). The models performed inference using a sliding window of observed data; at each time step, one new bin of input data was added to the window, and the remaining time steps consisted of previously observed data. This results in one new bin of model output. In addition, rather than sampling from the posterior distribution many times and averaging, we used the means of the posterior distributions. These modifications help to best simulate an online iBCI scenario in which minimal latency is desired. Models trained on the speech dataset used standard acausal inference and posterior sampling as the decoder requires a window of data to operate, making millisecond-scale latencies less of a concern.

### Power Consumption Analysis

The wireless iBCI recording device components that may differ in power consumption between LFP and spike data acquisition was assumed to include analog amplifiers, analog-to-digital converters, feature extractors, and wireless transmitters.

The power of the amplifier was calculated using the noise efficiency factor (NEF) formula (see, e.g., Nason, S. R. et al. A low-power band of neuronal spiking activity dominated by local single units improves the performance of brain-machine interfaces. Nat. Biomed. Eng. 4, 973-983 (2020); and Murmann, Boris. ADC Performance Survey 1997-2023. Github https://github.com/bmurmann/ADC-survey (2024)):

$${P}_{a m p} = {{V}_{s o u r c e} ( \frac{N E F}{{V}_{R M S}} )}^{2} \frac{π \cdot {U}_{T} \cdot 4 kT \cdot BW}{2}$$

where the voltage source V_{source} was 3.3V, the NEF was 4.0, the V_{RMS} was 2 μV, the thermal voltage U_{T} was 26.7 mV, the Boltzmann constant k is 1.38e-23, the temperature was 310 K, and BW was the signal bandwidth.

The power of the analog-to-digital converter (ADC) was calculated by solving the Schreier Figure of Merit (FoMₛ) formula:

$${P}_{A D C} = \frac{B W}{{10}^{\frac{FoMs - SNDR}{10}}}$$

where the FoMₛ was 185 dB, SNDR was 96 dB, and BW was the sampling bandwidth (half of the sampling rate). See, e.g., Nason, S. R. et al. A low-power band of neuronal spiking activity dominated by local single units improves the performance of brain-machine interfaces. Nat. Biomed. Eng. 4, 973-983 (2020); and Murmann, Boris. ADC Performance Survey 1997-2023. Github https://github.com/bmurmann/ADC-survey (2024).

Power consumption for feature extraction was not estimated because it has previously been shown that their consumption is orders of magnitude lower than that of the analog front-end. See, e.g., Nason, S. R. et al. A low-power band of neuronal spiking activity dominated by local single units improves the performance of brain-machine interfaces. Nat. Biomed. Eng. 4, 973-983 (2020). For the data transmitter, the transmission rate of the current state-of-the-art wireless iBCI recording device that was closely matched as transmission rate is the driving factor behind transmitter power consumption. See, e.g., Yoon, D.-Y. et al. A 1024-Channel Simultaneous Recording Neural SoC with Stimulation and Real-Time Spike Detection. in 2021 Symposium on VLSI Circuits 1-2 (2021). doi: 10.23919/VLSICircuits52068.2021.9492480; and Even-Chen, N. et al. Power-saving design opportunities for wireless intracortical brain-computer interfaces. Nat. Biomed. Eng. 4, 984-996 (2020). By matching transmission rate, data transmission power is matched between the disclosed LFP and spikes circuits, allowing us to focus on potential power savings from the analog front-end when recording LFP in place of spikes.

To mimic the potential data compression rates for spikes counted in 20 ms bins, the LFP power signal for each session was quantized by first min-max scaling each channel of data with respect to the entire session (approximately 15 minutes of data) so that it falls within the range of 0-2^{b}, where b is the number of bits in the resolution of interest, and flooring the resulting float values to integers. This simulates LFP data collection and compressed transmission from a wireless iBCI recording device. The resulting signal was used in two analyses. First, to assess whether data compression rates affect how well LFP power can predict behavior, the empirical quantized LFP power (Gaussian w/standard deviation 30 ms) was first smoothed and a decoder was trained. Later, to determine whether data compression rates had an impact on modeling performance, the quantized LFP power (unsmoothed) was used to train a neural dynamics model, and a decoder was trained on the output rates.

Model performance was further assessed at different LFP frequency bands by simulating a lower bandwidth signal. Here the frequency bands 150-450 Hz, 100-200 Hz, 50-100 Hz, 25-50 Hz, and 0-8 Hz were considered. The raw LFP signal was downsampled to the Nyquist frequency of the upper bound of the frequency range of interest (except for the 0-8 Hz band, for which was downsampled to 50 Hz, the lowest sampling rate to maintain the spiking bin size of 20 ms). Then, LFP power was computed and the resulting features were used to perform model inference and decoding.

### Neural Decoding

For both nonhuman primate motor datasets, we applied a Wiener filter decoder with 4 time bins of history and L2 regularization of the form was computed:

$$W = {( {X}^{T} X + {R}^{T} R )}^{- 1} {X}^{T} y$$

where W is a matrix of filter coefficients, X represents the predictor neural data with history and bias, and y represents the output behavioral data. R represents a diagonal matrix with the L2 regularization constant filling the diagonal. The bias term was not regularized and therefore the diagonal entry of R was set to zero. To determine the optimal L2 value, over 20 possible values spaced on a log scale (center out: 100-1000, random walk: 0.1-1000) was swept. Decoder weights was computed using 10-fold cross-validation and reported the resulting R² on a held-out validation set. The neural data used to predict behavior was either a smoothed empirical signal (LFP or spikes) or the LFADS output rates. To compute decoding accuracy, variance-weighted R² used was defined as:

$${R}^{2} ( y , \hat{y} ) = 1 - \frac{\begin{matrix}{\sum }_{d = 1}^{D} & {\sum }_{i = 1}^{N} & {( \hat{{y}_{ι , d}} - {y}_{i , d} )}^{2}\end{matrix}}{\begin{matrix}{\sum }_{d = 1}^{D} & {\sum }_{i = 1}^{N} & {( {y}_{i , d} - \overline{{y}_{d}} )}^{2}\end{matrix}}$$

For the speech task, the recurrent neural network decoder used was described in Willett et al., 2023. See, e.g., Willett, F. R. et al. A high-performance speech neuroprosthesis. Nature 620, 1031-1036 (2023). In brief, preprocessed neural data was passed through a linear layer, then into stacked gated recurrent units (GRU) RNNs, and finally into an output layer to produce phoneme predictions¹⁹. See, e.g., Card, N. S. et al. An accurate and rapidly calibrating speech neuroprosthesis. 2023. 12.26.23300110 Preprint at https://doi.org/10.1101/2023.12.26.23300110 (2024); and Willett, F. R. et al. A high-performance speech neuroprosthesis. Nature 620, 1031-1036 (2023). The model weights were optimized using connectionist temporal classification (CTC) loss, whose objective is to identify both when a new phoneme occurs and what the identity of that phoneme is. For each neural signal modality, model architecture and hyperparameters were selected by performing a random search of 200 decoder models. The neural data used to predict phonemes was either the smoothed raw signal (LFP or spikes) or the LFADS output rates. The decoding performance was quantified using the phoneme error rate (PER), defined as the edit distance of the decoded sequence (the number of substitutions, insertions, or deletions required to change the decoded sequence into the correct sequence) divided by the number of phonemes in the true sequence. In order to ensure model performance was consistent, five decoders were trained with different random seeds, using the same hyperparameters from the random search, and reported the mean and standard deviation across these models. To ensure that performance quantification focused on information within the neural signals themselves, a language model was not used to perform error correction after phoneme decoding, in contrast to the original use case. See, e.g., Willett, F. R. et al. A high-performance speech neuroprosthesis. Nature 620, 1031-1036 (2023).

### Results

LFP Requires Lower Power Consumption Than Spikes in a Wireless iBCI Circuit

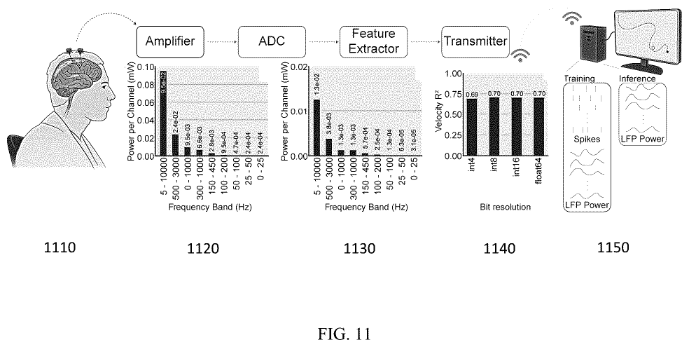

FIG. 11 shows a schematic of wireless iBCI circuit and power advantages conferred by LFP. FIG. 11 shows a schematic 1110 of circuit components in wireless iBCI. Neural activity can be processed through an amplifier, analog-to-digital converter (ADC), feature extraction pipeline, and finally wirelessly transmitted to a computer where any further preprocessing, modeling, and decoding can take place. As shown in 1120, power consumed by the amplifier per channel of neural activity for different frequency bands. Those considered include high-bandwidth spikes (5-10000 Hz), low bandwidth spikes (500-3000 Hz), the raw LFP used in this work (0-1000 Hz), spike band power (300-1000 Hz), the band of LFP power used for dynamics modeling in this work (150-450 Hz), and lower LFP bands (100-200 Hz, 50-100 Hz, 25-50 Hz, 0-25 Hz). As shown in 1130, power consumed by the ADC per channel of neural activity for the same frequency bands shown in 1120. As shown in 1140, decoding of LFP power in the 150-450 Hz band when represented at 4-bit, 8-bit, 16-bit, and 64-bit depth. As shown in 1150, components of neural activity required for training and performing inference with the disclosed LFP-based dynamics model.

We first aimed to assess the theoretical magnitude of differences in power consumption between LFP-and spikes-based wireless iBCIs (1110). Beginning with the amplifier, whose power requirements depend on the signal bandwidth, we computed the power consumed per channel of recorded neural data for a variety of frequency bands used to extract either spikes or LFP (1120; see Methods). We estimated the frequency range of 5 Hz to 10 KHz as a standard range for extracting spikes from high-bandwidth data; the amplifier in this range would consume 9.5e-2 mW per channel of neural data. However, spikes can also be extracted with adequate accuracy from lower bandwidth signals, such as 500-3000 Hz. See, e.g., Even-Chen, N. et al. Power-saving design opportunities for wireless intracortical brain-computer interfaces. Nat. Biomed. Eng. 4, 984-996 (2020). In this frequency range, the amplifier would consume 2.4e-2 mW per channel of neural data, only 25% of the power required for the high-bandwidth signal.

In this example, we largely analyzed an LFP signal containing frequencies 0-1000 Hz, which offers further power benefits, requiring only 9.5e-3 mW per channel. Recent work has also proposed spike band power (SBP; 300-1000 Hz) as a low power signal, which would require 6.6e-3 mW per channel. See, e.g., Nason, S. R. et al. A low-power band of neuronal spiking activity dominated by local single units improves the performance of brain-machine interfaces. Nat. Biomed. Eng. 4, 973-983 (2020). Better yet, our results largely used LFP power in the high-frequency band of 150-450 Hz; with further circuit optimizations, amplifier power consumption to collect a signal in this band would use only 2.8e-3 mW of power per channel (12% of the required per-channel power of low-bandwidth spikes and 42% of the required per-channel power of SBP). Lower bandwidth LFP signals (100-200 Hz, 50-100 Hz, 25-50 Hz, 0-25 Hz), whose advantages may differ based on the decoding application, may reduce amplifier power consumption to as low as 2.4e-4 mW per channel.

We next evaluated the power required by the analog-to-digital converter (ADC), which depends on the sampling bandwidth of the signal (1130). Again, we found that high-bandwidth spikes would require the most power per channel (1.3e-2 mW) followed by low-bandwidth spikes (3.8e-3 mW). The LFP signal recorded at 2 kHz would provide a significant advantage, necessitating 1.3e-3 mW. This value also holds for SBP as it requires collection at the same sampling rate and therefore has the same sampling bandwidth. Lower bandwidth signals recorded at their lower Nyquist sampling rates may even further lower ADC power requirements, with 150-450 Hz requiring only 5.7e-4 mW (15% of that required for low-bandwidth spikes) and the lowest sampling bandwidth of 0-25 Hz requiring only 3.1e-5 mW.

Moving through the circuit, LFP would unquestionably reduce the amplifier and ADC power necessary to collect neural signals. The feature extraction step, which involves computing signal power or extracting threshold crossings and binning to the desired width, consumes a negligible amount of power relative to the analog front-end. See, e.g., Nason, S. R. et al. A low-power band of neuronal spiking activity dominated by local single units improves the performance of brain-machine interfaces. Nat. Biomed. Eng. 4, 973-983 (2020). We next investigated the transmission step, which wirelessly sends the neural data to an external computer for further processing and decoding.

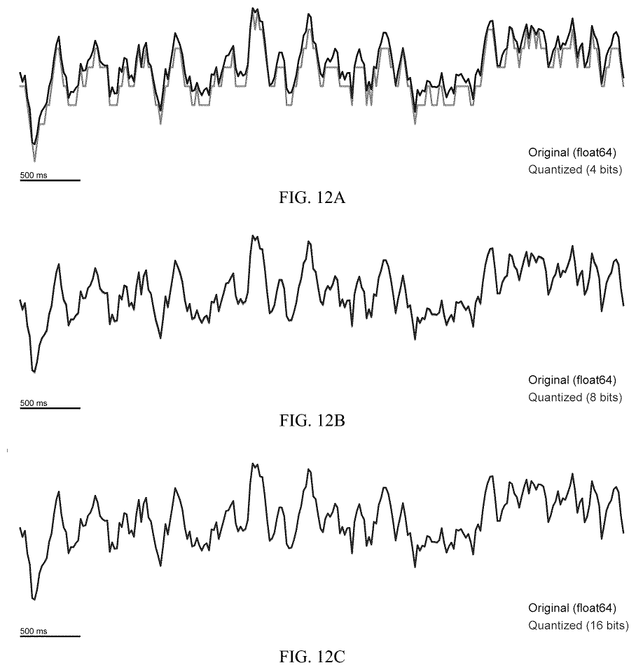

A continuous-valued signal such as LFP, transmitted wirelessly at high precision, would require more transmission power than a discrete signal. To assess whether one could maintain high-performance decoding while transmitting low precision LFP signals, we analyzed previously-collected data from a monkey center-out reaching dataset. We first quantized the LFP power to different resolutions (4-bit, 8-bit, 16-bit, and 64-bit; FIGS. 12A-C show visualization of LFP power at different quantization levels). We then smoothed the resulting signal and predicted cursor velocity using a Wiener filter, and we found that decoding accuracy remained steady at all signal resolutions (1140). As 4 bits per sample per channel was sufficient to preserve decoding, we estimated the transmission rate for 1024 channels for varying bin sizes and found it to range from 136.53 Kbps (30 ms bins) to 204.8 Kbps (20 ms bins). This is consistent with the current state-of-the-art wireless spikes-based iBCI, which operates at 163.84 Kbps to transmit spiking data from 1024 channels. See, e.g., Yoon, D.-Y. et al. A 1024-Channel Simultaneous Recording Neural SoC with Stimulation and Real-Time Spike Detection. in 2021 Symposium on VLSI Circuits 1-2 (2021). doi: 10.23919/VLSICircuits52068.2021.9492480.

After wireless transmission of the neural data, further preprocessing as well as model and decoder training and inference steps would take place on an external machine with sufficient computational resources. The disclosed dynamics model uses LFP power to reconstruct spikes. Therefore, for initial model training, both LFP power and spikes would be required (1150). This initial training dataset may be collected using a wired transmitter or with access to a high-power source such that power concerns are not at the forefront. After training, model inference only requires LFP power to yield estimates of firing rates that can be used for decoding. During this phase, we estimate significant power consumption advantages at the front-end using the amplifier and ADC and power consumption consistent with spikes-based devices for wireless transmission, saving at least 103.86 μW per channel (96.8%) compared to high-bandwidth spikes, 24.05 μW per channel (87.6%) compared to low-bandwidth spikes, and 4.48 μW per channel (56.8%) compared to SBP.

### LFP-Based Dynamics Models Accurately Reconstruct Spikes and Enable Power Reduction

We modeled dynamics using latent factor analysis via dynamical systems (LFADS; see Methods). Briefly, LFADS approximates the dynamical system underlying a neural population using a series of recurrent neural networks (RNNs). In standard Spikes LFADS, the model input is observed spiking activity, and its objective is to minimize a lower bound on the likelihood of the observed spiking activity given the instantaneous firing rates it has estimated to underlie each channel of neural activity. We modified this scheme for LFP LFADS such that the model input is now the LFP power, but the objective is still computed based on the likelihood of the spiking activity given estimated firing rates.

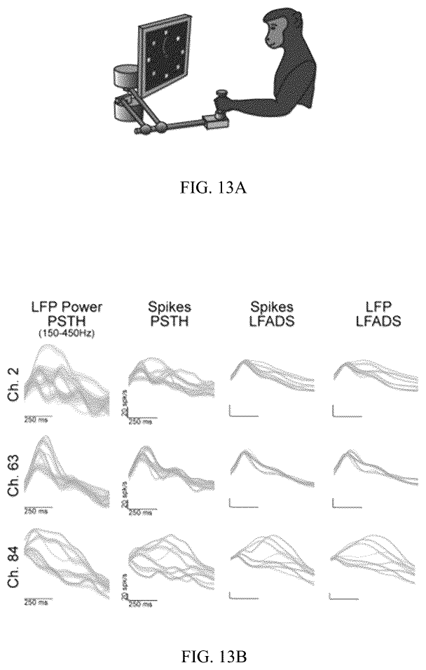

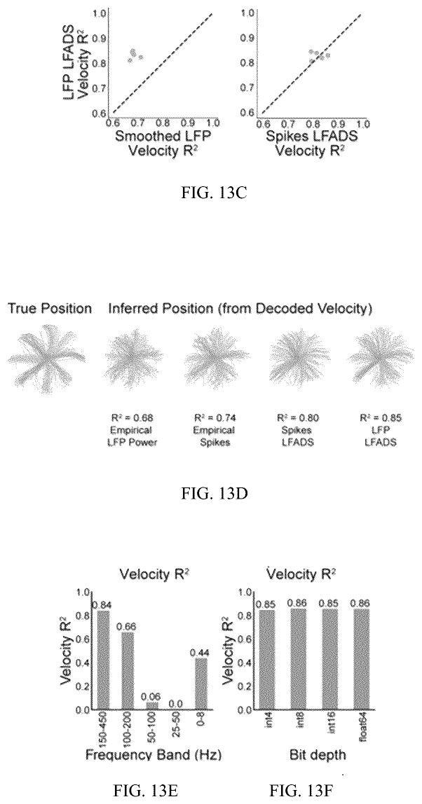

We began by testing the performance of LFP-based dynamics models by applying them to the monkey center-out reaching task (FIG. 13A). We compared the denoised rates from the LFP LFADS model to those of a standard Spikes LFADS model and to the empirical firing rates estimated by smoothing the spikes with a Gaussian kernel. We found that despite the difference in input signal, LFP LFADS models reconstructed firing rates in a qualitatively similar manner to Spikes LFADS models (FIG. 13B), as evidenced by their peri-stimulus time histograms (PSTHs). Further, both models' firing rate estimates appeared to be similar to the empirical Spikes PSTHs.

To better quantify whether our models captured information in the neural signal that was relevant to behavioral decoding, we assessed the decoding performance from each neural signal modality using a Wiener filter trained to predict cursor velocity. We used five sessions of neural data recorded on different days. On each session, we trained an LFP LFADS model, and then trained a decoder from the LFADS factors to the cursor velocity. We first compared the decoding performance (R²) to that of training a decoder on the smoothed LFP Power without any dynamics modeling. We found that decoding from LFP LFADS rates (mean R²=0.83) exceeded the performance of decoding from empirical LFP Power (mean R²=0.68) for all sessions (p=6.6e-5 in one-sided t-test) (FIG. 13C, left).

Next, the performance of decoders trained on LFP LFADS rates was compared to those trained on Spikes LFADS rates. We trained separate Spikes LFADS models and decoders on each of the five sessions. We found that Spikes LFADS rates yielded decoding performance very comparable to the LFP LFADS counterpart (mean R²=0.82), with no significant difference between the groups (p=0.64 in two-sided t-test) (FIG. 13C, right). These results were consistent with visualizations of the decoded cursor trajectories, shown for one session in FIG. 13D.

Because the frequency band used for modeling thus far was relatively high, the performance of LFP-based dynamics models was further evaluated when trained on features from lower frequency bands (FIG. 13E). For this experiment, we trained LFP-based dynamics models and decoders on four sessions of data collected on the same calendar day. We then downsampled the raw LFP signal to the Nyquist frequency of the upper bound of each frequency range prior to computing LFP power and computed velocity R² after applying the trained dynamics model and decoder. We found that while high-frequency LFP (150-450 Hz) remained the highest in terms of velocity decoding, some bands such as 100-200 Hz and 0-8 Hz offered reasonable decoding performance and may offer further benefits in amplifier or ADC power consumption. Other bands such as 50-100 Hz and 25-50 Hz yielded poor firing rate predictions with little relationship to behavior (near-zero decoding performance); this may be due to a lack of correspondence between the LFP in these bands and the precise timing of spikes, which has been shown in previous work. See, e.g., Gallego-Carracedo, C., Perich, M. G., Chowdhury, R. H., Miller, L. E. & Gallego, J. Á. Local field potentials reflect cortical population dynamics in a region-specific and frequency-dependent manner. eLife 11, e73155 (2022).

Finally, LFP-based dynamics models maintained their performance when using LFP features at a lower resolution was ensured (FIG. 13F). This is important to maintain the power required to transmit the data in our theoretical wireless iBCI recording device. We trained separate LFP-based dynamics models on an individual session of data (the same session used in FIG. 13B, D) after converting the LFP power features (150-450 Hz) to 4-bit, 8-bit, and 16-bit resolution. We found that no matter the resolution, the model yielded features that decoded velocity consistently, with negligible differences between them. Therefore, LFP-based dynamics models do not fail with lower resolution LFP, allowing us to maintain the iBCI recording device's potential power savings accrued by using LFP.

### LFP-Based Dynamics Models Demonstrate High Reconstruction and Decoding Performance in an Unstructured Monkey Random Target Reaching Task

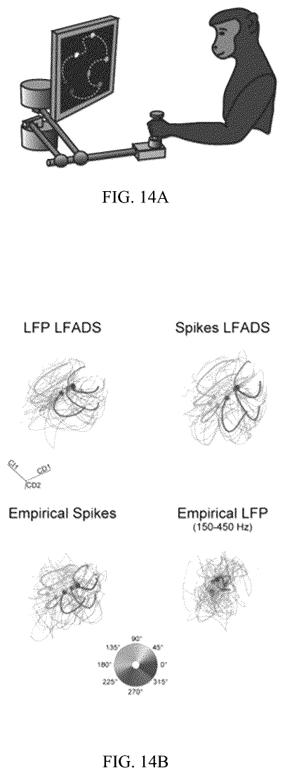

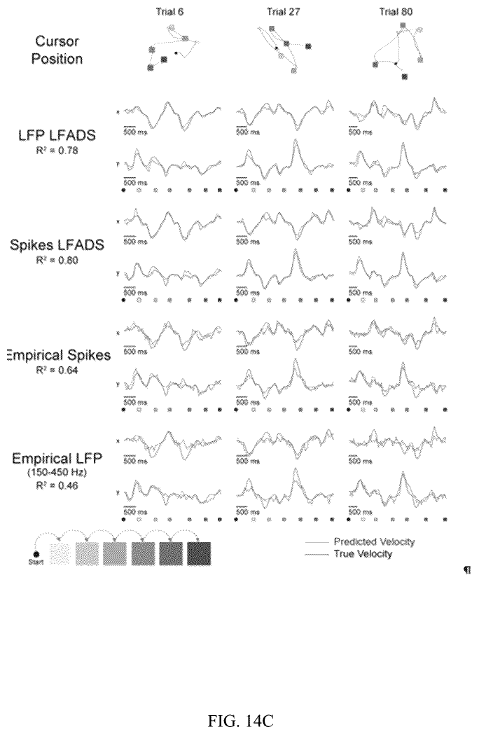

Next, LFP-based dynamics models were tested on a monkey random target reaching task to ensure it could transfer to a less structured behavior (FIG. 14A). On each trial, a monkey controlled a manipulandum to reach six successive targets that appeared one after the other randomly on the screen.

To assess how well the models captured the neural data, summarize the estimated firing rates using demixed principal components analysis (dPCA) was summarized. See, e.g., Kobak, D. et al. Demixed principal component analysis of neural population data. eLife 5, e10989 (2016). We fit the parameters of dPCA using the firing rates of the LFP LFADS model by binning trials into groups based on relative angle, and then applied those parameters to the Spikes LFADS model rates as well as the Empirical Spikes and Empirical LFP power. We visualized each reach segment between each pair of targets separately, shaded by the relative angle between the two targets (FIG. 14B). The LFP LFADS and Spikes LFADS trajectories both captured clear structure consistent with previous analyses of similar tasks. See, e.g., Keshtkaran, M. R. et al. A large-scale neural network training framework for generalized estimation of single-trial population dynamics. Nat. Methods 19, 1572-1577 (2022). Additionally, both models revealed more obvious task-based organization in the neural data than either the Empirical Spikes or Empirical LFP, further highlighting the benefit of dynamics modeling. We finally evaluated velocity decoding by training a Wiener filter from each neural signal modality to predict cursor velocity (FIG. 14C). Predictions from LFP LFADS rates (R2=0.78) were comparable in accuracy and structure to those from Spikes LFADS (R2=0.80). They again exceeded that of both the Empirical Spikes (R2=0.64) and the Empirical LFP power (R2=0.46).

### LFP-Based Dynamics Models Exhibit Strong Reconstruction and Decoding Performance in a Human Attempted Speech Task

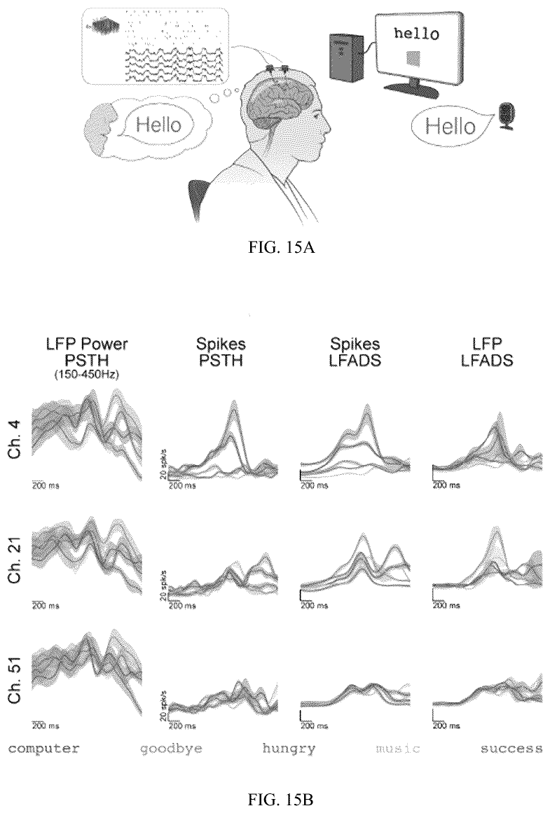

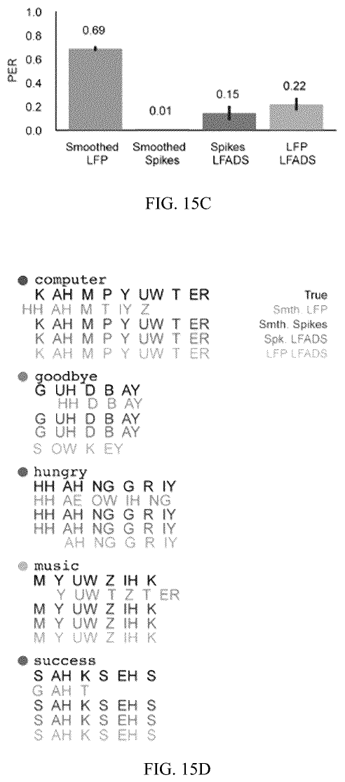

To assess the utility of LFP-based dynamics models in a more complex speech task performed by a human participant (FIG. 15A), we performed an offline analysis of an open-loop attempted speech task in which participant T16 was asked to attempt to say one word from a 50-word vocabulary on each trial. See, e.g., Moses David A. et al. Neuroprosthesis for Decoding Speech in a Paralyzed Person with Anarthria. N. Engl. J. Med. 385, 217-227 (2021). In a closed-loop version of the task, the only difference is that decoded phonemes are displayed to the participant following vocalization. The participant does not receive decoder feedback during vocalization in either version of the task, which yields a close correspondence between neural activity in the open-and closed-loop tasks and suggests that the offline decoding results, which are by nature open-loop, have a high likelihood of translating to online (closed-loop) performance.

We again visualized the consistency of PSTHs for the empirical and LFADS output signals (FIG. 15B). We found that LFP power appeared quite consistent across channels, and that there was a greater structural difference between the LFP Power PSTHs (the input signal) and the Spikes PSTHs (the output signal) than in the reaching datasets. Despite these features, there remained a strong qualitative similarity between the LFP LFADS and Spikes LFADS PSTHs.

We next trained the phoneme decoder to predict the intended sequence of phonemes from each of the four neural signal modalities. Our dataset consisted of 400 total trials (8 repeats of each word), of which we reserved 20% for decoder validation. We trained decoders with five different random seeds to ensure consistency of the reported prediction accuracy on validation trials as phoneme error rate (PER) (FIG. 15C). We found that Smoothed LFP yielded the lowest performance (highest prediction error) of all four possible signals (mean PER=0.69±0.02). Smoothed Spikes consistently yielded the highest performance (lowest error; mean PER=0.01±0).

LFP LFADS rates (mean PER=0.22±0.05) and Spikes LFADS rates (mean PER=0.15±0.06) offered similar levels of error (p=0.06 in two-sided Wilcoxon signed-rank test). The consistency in performance between Spikes LFADS and LFP LFADS indicates that the two model types produced outputs that encode similar amounts of phoneme-related information (example phoneme predictions shown in FIG. 15D). The increase in PER from smoothed spikes to both types of LFADS model outputs indicates that the dynamical models may fail to capture some information that is important for phoneme decoding, and that further innovations in dynamics models or adjustments to phoneme decoders are needed.

### Discussion

We introduced a new paradigm for training LFP-based dynamics models to reconstruct spiking activity with the goal of reducing power consumption while maintaining decoding performance with respect to spikes-based models. In our tests, LFP-based dynamics models performed comparably to spikes-based dynamics models and dramatically better than LFP alone for tasks encompassing nonhuman primate reaching and human speech. Importantly, this performance can be maintained by running model inference with signals collected with much lower power than those used with traditional spikes-based decoders.

While in this example, experiments were performed using LFADS as our dynamics model, these results can hold with other base neural dynamics models such as dynamics models based on neural ordinary differential equations (see, e.g., Sedler, A. R., Versteeg, C. & Pandarinath, C. Expressive architectures enhance interpretability of dynamics-based neural population models. Preprint at https://doi.org/10.48550/arXiv.2212.03771 (2023); and Kim, T. D., Luo, T. Z., Pillow, J. W. & Brody, C. D. Inferring Latent Dynamics Underlying Neural Population Activity via Neural Differential Equations. in Proceedings of the 38th International Conference on Machine Learning 5551-5561 (PMLR, 2021)) or feedback control algorithms (see, e.g., Schimel, M., Kao, T.-C., Jensen, K. T. & Hennequin, G. ILQR-VAE: control-based learning of input-driven dynamics with applications to neural data. 2021.10.07.463540 Preprint at https://doi.org/10.1101/2021.10.07.463540 (2022)), or with transformer models that use large context windows to denoise neural data like the Neural Data Transformer (NDT) (see, e.g., Ye, J. & Pandarinath, C. Representation learning for neural population activity with Neural Data Transformers. Preprint at https://doi.org/10.48550/arXiv.2108.01210 (2021)).

Neural dynamics models can also achieve spatio-temporal super-resolution by inferring missing samples from high-channel-count time series datasets. See, e.g., Zhu, F. et al. Deep inference of latent dynamics with spatio-temporal super-resolution using selective backpropagation through time. Adv. Neural Inf. Process. Syst. 34 (2021). Such an approach may be advantageous in increasing the number of channels that can be used for decoding while keeping power consumption constant: each channel could be sparsely sampled in time so long as neural dynamics models are trained to infer the missing timesteps. In combination with our efforts to lower wireless iBCI recording device power consumption, super-resolution training approaches may be particularly useful for decoding applications where channel count has been shown to be an important factor in performance, such as in speech decoding. See, e.g., Willett, F. R. et al. A high-performance speech neuroprosthesis. Nature 620, 1031-1036 (2023).

A commonly cited advantage of LFP can be its robustness over time: while spike detection is sensitive to recording interface instabilities due to microshifts in array position or changes in array or tissue properties over time, LFP tends to remain more stable. See, e.g., Flint, R. D., Wright, Z. A., Scheid, M. R. & Slutzky, M. W. Long term, stable brain machine interface performance using local field potentials and multiunit spikes. J. Neural Eng. 10, 056005 (2013); and Milekovic, T. et al. Stable long-term BCI-enabled communication in ALS and locked-in syndrome using LFP signals. J. Neurophysiol. 120, 343-360 (2018). As a result, the disclosed LFP-based dynamics modeling approach can have further benefits for stable iBCI decoding, both on its own and in combination with manifold alignment approaches. See, e.g., Karpowicz, B. M. et al. Stabilizing brain-computer interfaces through alignment of latent dynamics. 2022.04.06.487388 Preprint at https://doi.org/10.1101/2022.04.06.487388 (2022); Ma, X., Bodkin, K. L. & Miller, L. E. Population Activity in Motor Cortex is Influenced by the Contexts of the Motor Behavior. in 2021 10th International IEEE/EMBS Conference on Neural Engineering (NER) 1152-1155 (2021). doi: 10.1109/NER49283.2021.9441430; and Degenhart, A. D. et al. Stabilization of a brain-computer interface via the alignment of low-dimensional spaces of neural activity. Nat. Biomed. Eng. 4, 672-685 (2020). For example, by using a model trained on data from early in the device lifetime, our approach can enable recovery of decoding performance after array degradation has occurred such that spikes can no longer reliably be detected, extending upon previous spikes-based approaches. See, e.g., Kao, J. C., Ryu, S. I. & Shenoy, K. V. Leveraging neural dynamics to extend functional lifetime of brain-machine interfaces. Sci. Rep. 7, 7395 (2017). In addition, our multi-session modeling results provide initial evidence that the robust qualities of the LFP signal may allow for unsupervised aggregation of data across sessions, in comparison to approaches like LFADS “stitching” that have previously required knowledge of task structure. See, e.g., Pandarinath, C. et al. Inferring single-trial neural population dynamics using sequential auto-encoders. Nat. Methods 15, 805-815 (2018).

In some examples, a model according to some embodiments can be trained using the LFP and spikes from one individual to reconstruct neural firing rates from the LFP of another individual. For example, spikes can be estimated from other sources of LFP with different properties than the signals used in this example, such as that recorded using electrocorticography, or other devices that record signals that typically cannot yield high-fidelity spiking activity on their own.

### Example 4

FIG. 16 depicts a block diagram of an example computing system 1600 for implementing certain embodiments. For example, in some aspects, the computer system 1600 may include computing systems associated with a device (e.g., the system 110) performing one or more processes (e.g., FIGS. 2-5 and 7) disclosed herein. The block diagram illustrates some electronic components or subsystems of the computing system. The computing system 1600 depicted in FIG. 16 is merely an example and is not intended to unduly limit the scope of inventive embodiments recited in the claims. One of ordinary skill in the art would recognize many possible variations, alternatives, and modifications. For example, in some implementations, the computing system 1600 may have more or fewer subsystems than those shown in FIG. 16, may combine two or more subsystems, or may have a different configuration or arrangement of subsystems.

In the example shown in FIG. 16, the computing system 1600 may include one or more processing units 1610 and storage 1620. The processing units 1610 may be configured to execute instructions for performing various operations, and can include, for example, a micro-controller, a general-purpose processor, or a microprocessor suitable for implementation within a portable electronic device, such as a Raspberry Pi. The processing units 1610 may be communicatively coupled with a plurality of components within the computing system 1600. For example, the processing units 1610 may communicate with other components across a bus. The bus may be any subsystem adapted to transfer data within the computing system 1600. The bus may include a plurality of computer buses and additional circuitry to transfer data.

In some embodiments, the processing units 1610 may be coupled to the storage 1620. In some embodiments, the storage 1620 may offer both short-term and long-term storage and may be divided into several units. The storage 1620 may be volatile, such as static random access memory (SRAM) and/or dynamic random access memory (DRAM), and/or non-volatile, such as read-only memory (ROM), flash memory, and the like. Furthermore, the storage 1620 may include removable storage devices, such as secure digital (SD) cards. The storage 1620 may provide storage of computer readable instructions, data structures, program modules, audio recordings, image files, video recordings, and other data for the computing system 1600. In some embodiments, the storage 1620 may be distributed into different hardware modules. A set of instructions and/or code might be stored on the storage 1620. The instructions might take the form of executable code that may be executable by the computing system 1600, and/or might take the form of source and/or installable code, which, upon compilation and/or installation on the computing system 1600 (e.g., using any of a variety of generally available compilers, installation programs, compression/decompression utilities, and the like), may take the form of executable code.

In some embodiments, the storage 1620 may store a plurality of application modules 1624, which may include any number of applications, such as applications for controlling input/output (I/O) devices 1640 (e.g., sensor(s) (e.g., sensor(s) 1670, other sensor(s), etc.)), a switch, a camera, a microphone or audio recorder, a speaker, a media player, a display device, etc.). The application modules 1624 may include particular instructions to be executed by the processing units 1610. In some embodiments, certain applications or parts of the application modules 1624 may be executable by other hardware modules, such as a communication subsystem 1650. In certain embodiments, the storage 1620 may additionally include secure memory, which may include additional security controls to prevent copying or other unauthorized access to secure information.

In some embodiments, the storage 1620 may include an operating system 1622 loaded therein, such as an Android operating system or any other operating system suitable for mobile devices or portable devices. The operating system 1622 may be operable to initiate the execution of the instructions provided by the application modules 1624 and/or manage other hardware modules as well as interfaces with a communication subsystem 1650 which may include one or more wireless or wired transceivers. The operating system 1622 may be adapted to perform other operations across the components of the computing system 1600 including threading, resource management, data storage control, and other similar functionality.

The communication subsystem 1650 may include, for example, an infrared communication device, a wireless communication device and/or chipset (such as a Bluetooth® device, an IEEE 802.11 (Wi-Fi) device, a WiMax device, cellular communication facilities, and the like), NFC, ZigBee, and/or similar communication interfaces. The computing system 1600 may include one or more antennas (not shown in FIG. 16) for wireless communication as part of the communication subsystem 1650 or as a separate component coupled to any portion of the system.

Depending on desired functionality, the communication subsystem 1650 may include separate transceivers to communicate with base transceiver stations and other wireless devices and access points, which may include communicating with different data networks and/or network types, such as wireless wide-area networks (WWANs), WLANs, or wireless personal area networks (WPANs). A WWAN may be, for example, a WiMax (IEEE 802.9) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. In some embodiments, the communications subsystem 1650 may include wired communication devices, such as Universal Serial Bus (USB) devices, Universal Asynchronous Receiver/Transmitter (UART) devices, Ethernet devices, and the like. The communications subsystem 1650 may permit data to be exchanged with a network, other computing systems, and/or any other devices described herein. The communication subsystem 1650 may include a means for transmitting or receiving data, such as identifiers of portable goal tracking devices, position data, a geographic map, a heat map, photos, or videos, using antennas and wireless links. The communication subsystem 1650, the processing units 1610, and the storage 1620 may together comprise at least a part of one or more of a means for performing some functions disclosed herein.

The computing system 1600 may include one or more I/O devices 1640, such as sensors 1670, a switch, a camera, a microphone or audio recorder, a communication port, or the like. For example, the I/O devices 1640 may include one or more touch sensors or button sensors associated with the buttons. The touch sensors or button sensors may include, for example, a mechanical switch or a capacitive sensor that can sense the touching or pressing of a button.

In some embodiments, the I/O devices 1640 may include a microphone or audio recorder that may be used to record an audio message. The microphone and audio recorder may include, for example, a condenser or capacitive microphone using silicon diaphragms, a piezoelectric acoustic sensor, or an electret microphone. In some embodiments, the microphone and audio recorder may be a voice-activated device. In some embodiments, the microphone and audio recorder may record an audio clip in a digital format, such as MP3, WAV, WMA, DSS, etc. The recorded audio files may be saved to the storage 1620 or may be sent to the one or more network servers through the communication subsystem 1650.

In some embodiments, the I/O devices 1640 may include a location tracking device, such as a global positioning system (GPS) receiver. In some embodiments, the I/O devices 1640 may include a wired communication port, such as a micro-USB, Lightning, or Thunderbolt transceiver.

The I/O devices 1640 may also include, for example, a speaker, a media player, a display device, a communication port, or the like. For example, the I/O devices 1640 may include a display device, such as an LED or LCD display and the corresponding driver circuit. The I/O devices 1640 may include a text, audio, or video player that may display a text message, play an audio clip, or display a video clip.

The computing system 1600 may include a power device 1660, such as a rechargeable battery for providing electrical power to other circuits on the computing system 1600. The rechargeable battery may include, for example, one or more alkaline batteries, lead-acid batteries, lithium-ion batteries, zinc-carbon batteries, and NiCd or NiMH batteries. The computing system 1600 may also include a battery charger for charging the rechargeable battery. In some embodiments, the battery charger may include a wireless charging antenna that may support, for example, one of Qi, Power Matters Association (PMA), or Association for Wireless Power (A4WP) standard, and may operate at different frequencies. In some embodiments, the battery charger may include a hard-wired connector, such as, for example, a micro-USB or Lightning® connector, for charging the rechargeable battery using a hard-wired connection. The power device 1660 may also include some power management integrated circuits, power regulators, power converters, and the like.

In some embodiments, the computing system 1600 may include one or more sensors 1670. The sensors 1670 may include, for example, the sensors as described above.

The computing system 1600 may be implemented in many different ways. In some embodiments, the different components of the computing system 1600 described above may be integrated to a same printed circuit board. In some embodiments, the different components of the computing system 1600 described above may be placed in different physical locations and interconnected by, for example, electrical wires. The computing system 1600 may be implemented in various physical forms and may have various external appearances. The components of computing system 1600 may be positioned based on the specific physical form.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a subscription and data receiving associated with a different subscription, such identifiers are merely for convenience and are not meant to limit various embodiments to a particular order, sequence, type of network or carrier.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing systems, (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or code on a non-transitory computer readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, and the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The disclosures of each and every publication cited herein are hereby incorporated herein by reference in their entirety.

While the disclosure has been described in detail with reference to exemplary embodiments, those skilled in the art will appreciate that various modifications and substitutions may be made thereto without departing from the spirit and scope of the disclosure as set forth in the appended claims. For example, elements and/or features of different exemplary embodiments may be combined with each other and/or substituted for each other within the scope of this disclosure and appended claims.

What is claimed:

1. A computer-implemented method, comprising:
receiving a training dataset of neural data for at least one subject, the training dataset including measured field potential data and measured spiking data; and
training a neural network architecture to estimate spiking data from the field potential data, wherein the neural network architecture includes a dynamics model.

2. The method according claim 1, further comprising:
augmenting the measured field potential data.

3. The method according to claim 1, further comprising:
determining one or more batches of the measured field potential data.

4. The method according to claim 3, further comprising:
processing each batch of the measured field potential data to estimate the spiking data;
comparing the estimated spiking data and the measured spiking data for each batch to determine loss; and
updating the neural network parameters based on the loss.

5. The method according to claim 1, wherein the neural network architecture includes a read-in model, and the training further includes:
transforming the measured field potential data to a standardized dimension using the read-in model.

6. The method according to claim 5, wherein the training further includes:
processing the measured field potential data through the dynamics model to determine an estimate of latent dynamics trajectories.

7. The method according to claim 5, wherein the neural network architecture includes a read-out model and the training further includes:
processing the latent dynamics trajectories through a read-out model to estimate the spiking data as denoised firing rates.

8. A system, comprising:
one or more processors; and
one or more hardware storage devices having stored thereon computer-executable instructions which are executable by the one or more processors to cause the computing system to perform at least the following:
receiving a training dataset of neural data for at least one subject, the training dataset including measured field potential data and measured spiking data; and
training a neural network architecture to estimate spiking data from the field potential data, wherein the neural network architecture includes a dynamics model.

9. The system according to claim 8, wherein the one or more processors are further configured to cause the computing system to perform at least the following:
augmenting the measured field potential data.

10. The system according to claim 8, wherein the one or more processors are further configured to cause the computing system to perform at least the following:
determining one or more batches of the measured field potential data.

11. The system according to claim 10, wherein the one or more processors are further configured to cause the computing system to perform at least the following:
processing each batch of the measured field potential data to estimate the spiking data;
comparing the estimated spiking data and the measured spiking data for each batch to determine loss; and
updating the neural network parameters based on the loss.

12. The system according to claim 8, wherein the neural network architecture includes a read-in model, and the training further includes:
transforming the measured field potential data to a standardized dimension using the read-in model.

13. The system according to claim 12, wherein the training further includes:
processing the measured field potential data through the dynamics model to determine an estimate of latent dynamics trajectories.

14. The system according to claim 12, wherein the neural network architecture includes a read-out model and the training further includes:
processing the latent dynamics trajectories through a read-out model to estimate the spiking data as denoised firing rates.

15. A computer-program product tangibly embodied in a non-transitory machine-readable storage medium, including instructions configured to cause one or more data processors to perform operations including:
receiving a training dataset of neural data for at least one subject, the training dataset including measured field potential data and measured spiking data; and
training a neural network architecture to estimate spiking data from the field potential data, wherein the neural network architecture includes a dynamics model.

16. The computer-program product of claim 15, wherein the one or more data sets includes location data that identifies one or more locations at which the particular electronic device was located, and wherein processing the one or more data sets comprises:
augmenting the measured field potential data.

17. The computer-program product of claim 16, wherein the one or more data sets includes location data that identifies one or more locations at which the particular electronic device was located, and wherein processing the one or more data sets comprises:
determining one or more batches of the measured field potential data,
processing each batch of the measured field potential data to estimate the spiking data;
comparing the estimated spiking data and the measured spiking data for each batch to determine loss; and
updating the neural network parameters based on the loss.

18. The computer-program product of claim 16, wherein the neural network architecture includes a read-in model, and the training further includes:
transforming the measured field potential data to a standardized dimension using the read-in model.

19. The computer-program product of claim 18, wherein the training further includes:
processing the measured field potential data through the dynamics model to determine an estimate of latent dynamics trajectories.

20. The computer-program product of claim 18, wherein the neural network architecture includes a read-out model and the training further includes:
processing the latent dynamics trajectories through a read-out model to estimate the spiking data as denoised firing rates.
